(19) United States
(12) Patent Application Publication
(10) Pub. No.: US 2014/0303812 A1
(43) Pub. Date: Oct. 9, 2014

(54) BACKUP CONTROL SYSTEM

(71) Applicant: HAMILTON SUNDSTRAND CORPORATION, Windsor Locks, CT (US)

(72) Inventors: Steven A. Avritch, Bristol, CT (US); Christopher Noll, Glastonbury, CT (US)

(73) Assignee: Hamilton Sundstrand Corporation, Windsor Locks, CT (US)

(21) Appl. No.: 13/857,281

(22) Filed: Apr. 5, 2013

(51) Int. Cl. B64C 19/00

(52) U.S. Cl. CPC B64C 19/00
USPC 701/3

(57) ABSTRACT

An aircraft control system includes an effector module connected to a control input and a primary control module connected to the effector module. A microprocessor in the effector module provides a backup control path bypassing the primary control module when the primary control module is in a failed state.

### TECHNICAL FIELD

The present disclosure relates generally to aircraft control systems, and more specifically to a backup control system for use in a redundant control system.

### BACKGROUND OF THE INVENTION

Aircraft designs utilize control systems that incorporate redundancies within the aircraft in order to ensure that safe control of the aircraft can be maintained in the event of a control system failure. Typically, the control systems include redundant controllers with two or more parallel control paths. The redundant controllers allow full control of the aircraft to be maintained in the event of a failure within one or more of the redundant control paths.

To further bolster the safety and reliability of the controls, commercial aircraft typically include a backup control path within each of the redundant control paths. The backup control paths utilize a different control architecture and/or different hardware than the primary control paths. In the case of a fault within a control path, the different architecture and/or hardware of the backup control path can prevent the fault from propagating from the primary control path to the backup control path.

Thus, in existing systems a basic control path for a controlled device, such as an actuator, on an aircraft includes at least four separate control paths: two redundant primary control paths, and a backup control path corresponding to each primary control path. In existing systems, each of the backup control paths is typically constructed of separate and independent hardware from the primary control paths, resulting in significant weight increases of the aircraft.

### SUMMARY OF THE INVENTION

Disclosed is an aircraft control system including a control input; an effector module connected to the control input, the effector module including at least one microprocessor, and having at least a primary control module output, a primary control module input, and a controlled device output, and a primary control module connected to the primary control module output of the effector module and the primary control module input of the effector module, the primary control module including at least one microprocessor, and wherein the at least one processor in the effector module provides a backup control path bypassing the primary control module when the primary control module is in a failed state.

Also disclosed is a method of controlling an aircraft system comprising the steps of: receiving a pilot input command at an effector module, determining a movement instruction for a controlled aircraft component based on the pilot input command and at least flight critical sensor information in a microprocessor of the effector module when a primary control module is in a failed state, and outputting the movement instruction to the controlled aircraft component, thereby controlling the controlled aircraft component.

Also disclosed is an aircraft control system including a control input, an effector module connected to the control input, the effector module including at least one microprocessor, and having at least a primary control module output, a primary control module input, and a controlled device output, a primary control module connected to the primary control module output of the effector module and the primary control module input of the effector module, the primary control module including at least one microprocessor, and wherein said at least one microprocessor in the effector module is operable to provide a backup control path bypassing the primary control module in response to the primary control module entering a failed state.

These and other features of the present invention can be best understood from the following specification and drawings, the following of which is a brief description.

### BRIEF DESCRIPTION OF THE DRAWINGS

FIG. 1 schematically illustrates a control system for controlling an aircraft component.

FIG. 2 schematically illustrates an example effector module for use in the control system of FIG. 1.

FIG. 3 schematically illustrates an example primary control processor module for use in the control system of FIG. 1.

FIG. 4 illustrates a control path of a healthy control system.

FIG. 5 schematically illustrates a control path of a control system including a fault in the primary control processor module.

### DETAILED DESCRIPTION OF AN EMBODIMENT

Flight systems for commercial aircraft, such as primary and secondary flight control surfaces, thrust control, or other flight related systems, include multiple levels of redundancy and hardware dissimilarity in the corresponding control systems in order to achieve at least a minimum level of reliability. Example control systems include a primary control path and a backup control path. The backup control path allows for continued control of the flight systems when the primary control path experiences a fault.

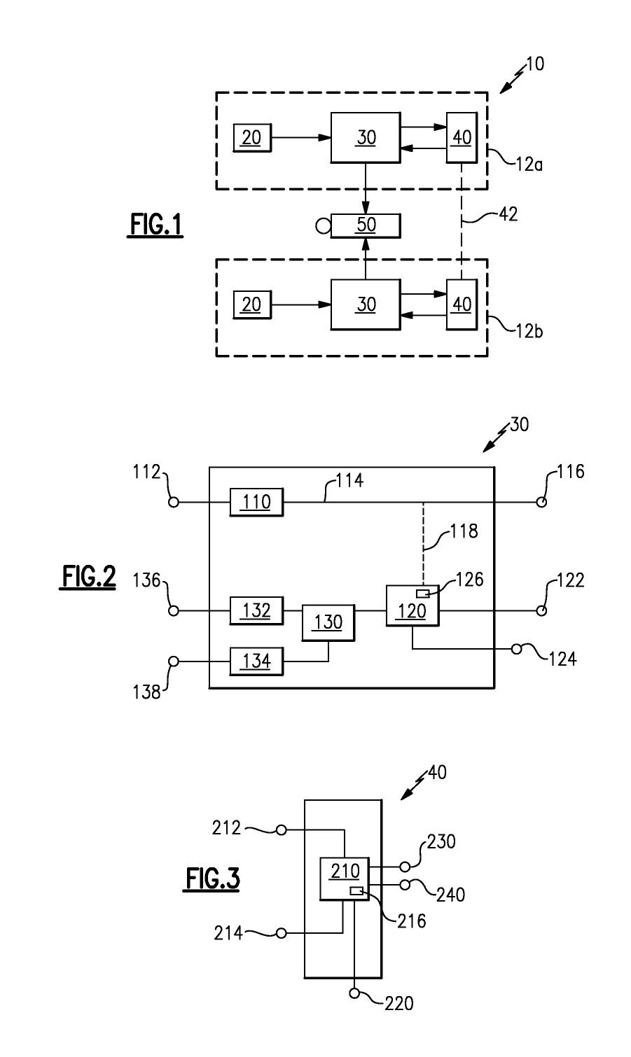

FIG. 1 schematically illustrates an example redundant control system 10 having two redundant control paths 12a, 12b. Each of the control paths 12a, 12b receives a pilot input command from a pilot input device 20, such as a control stick or autopilot function. The pilot input command from the pilot input device 20 undergoes preliminary processing in an input command processor of an effector module 30. The processed pilot input command is then passed to a primary control module 40.

The primary control module 40 utilizes the processed pilot input command, combined with multiple sensor readings from throughout the aircraft to perform intense control calculations and determine a corresponding position instruction for an effector/actuator 50. The determined position instruction is passed to the effector module 30 where it is digitally processed, using a processor, to convert the position instruction from the control module 40 into movement commands for the effector/actuator 50. The effector module 30 then passes the movement commands to the effector/actuator 50 using a feedback control loop, thereby controlling the effector/actuator 50 according to the pilot or autopilot input commands.

Each of the primary control modules 40 are cross linked to the other primary control module 40 using a monitor line 42. The cross linking allows each primary control module 40 to assert full control of the control system 10 should the other primary control module 40 encounter a debilitating fault.

Both the effector module 30 and the primary control module 40 utilize a processor based digital control algorithm to generate the appropriate controls according to known control practices. The control processors within the effector module 30 and the primary control module 40 utilize different hardware architecture. The different hardware architecture allows the processor in the effector module 30 to act as a backup control path without propagating certain types of failures within the primary control module 40 to the effector module 30 in the event of a primary control module 40 failure. Thus, the example system of FIG. 1 provides the functionality of a backup control system within a redundant control system, without requiring the implementation of new independent backup control system hardware, and without incurring a weight penalty.

With continued reference to FIG. 1, FIG. 2 schematically illustrates the effector module 30 of one example control system 10 in greater detail. As described above, the effector module 30 includes an input processing module 110 that accepts an input signal 112 from a pilot input device 20 and outputs a processed pilot control device input signal on an output 114. The input processing module 110 converts the input signal 112 into a form readable by an effector module processor 120 and readable by the primary control module 40. While the input processing module 110 and the effector module processor 120 are illustrated herein as separate physical processing elements, in an alternate embodiment, both the input processing module 110 and the effector module 120 are software functions with a single controller and the backup control link 118 is an exchange in the controllers memory.

The output 114 (the pilot/auto pilot command data) is provided to the primary control module 40 via an output 116. The primary control module 40 determines a position instruction for the effector/actuator 50 and outputs the position instruction to the effector module processor 120 on an effector module processor input 122. The output 114 of the input processing module 110 is also connected to the effector module processor 120 via a backup control link 118. In order to further facilitate backup control within the effector module processor 120, the effector module processor receives an input 124 corresponding to flight critical sensor information. While the schematic representation of the effector module indicates a single flight critical sensor input 124, it is understood that multiple inputs can be utilized, with one or more input corresponding to each flight critical sensor value.

The effector module processor 120 processes the position instruction from the primary control module 40, and converts the position instruction into a movement instruction for the effector/actuator 50. The movement instruction is then passed to a closed control loop processing module 130 that provides closed loop control of the actuator 50, thereby driving the effector/actuator 50 to the determined position using the movement instruction. The closed loop processing module outputs a command signal 136 to the effector/actuator 50 through an output conditioning module 132, and receives a feedback loop input 138 from the effector/actuator 50 through a feedback input conditioning module 134, thereby completing the feedback loop.

While the schematic illustration of FIG. 2 illustrates multiple discrete modules 110, 130, 132, 134 distinct from the effector module processor 120 within the effector module 30, an alternate configuration can utilize a single processor in the effector module 30. In the alternate configuration, each of the illustrated modules 110, 120, 130 are discrete software modules stored in a processor memory 126 of the effector module 30.

With continued reference to FIGS. 1 and 2, FIG. 3 schematically illustrates the primary control module 40 in greater detail. Included within the primary control module 40 is a processor 210. The processor 210 includes a memory 216 that stores instructions for converting a pilot/autopilot input commands into a desired effector/actuator position instruction(s). The primary control module 40 also includes an input 212 that passes the processed input signal from the output 116 of the effector module 30 to the controller 210 of the primary control module 40. The primary control module 40 also includes a flight critical control sensor input 230 and a non-flight critical control sensor input 240. Each of the sensor inputs 230, and 240 provide the controller 210 with sensor information that is utilized to perform the intense control calculations of the primary controller 210. The primary controller 210 also includes an output 214 that passes the position instruction back to the effector module 30. As with the sensor inputs 124 to the effector module processor 120, the single schematic inputs 230, 240 are representative of multiple sensor inputs.

A combined input/output connection 220 connects the controller 210 in the primary control module 40 to a controller 210 in a redundant path primary control module 40. The combined input/output connection 220 enables the above described cross linking between the primary control modules 40 of the redundant paths, thereby allowing a non-faulty control path to assert control when a fault occurs in the other of the control paths.

The control processes performed by the primary control module 40 are digital control processes, and do not require specific analog hardware to perform the control calculations and determine the desired effector/actuator position instruction. Because the determination of the desired position instruction is performed digitally, it is possible to utilize the effector module processor 120 of the effector module 30 to determine a position instruction based on flight critical sensor information. This functionality is invoked in the case of a fault in the primary control module 40 as the backup control path.

In an alternate example, the effector module 30 is connected to both the flight-critical sensor information and the non-flight critical sensor information. In the alternate example control system, a position instruction accounting for all the sensed information is determined in the backup control path. Furthermore, because the effector module processor 120 has a different processor architecture than the primary control module processor 210, the chance of faults being propagated from the primary control processor 210 to the effector module processor 120 is minimized.

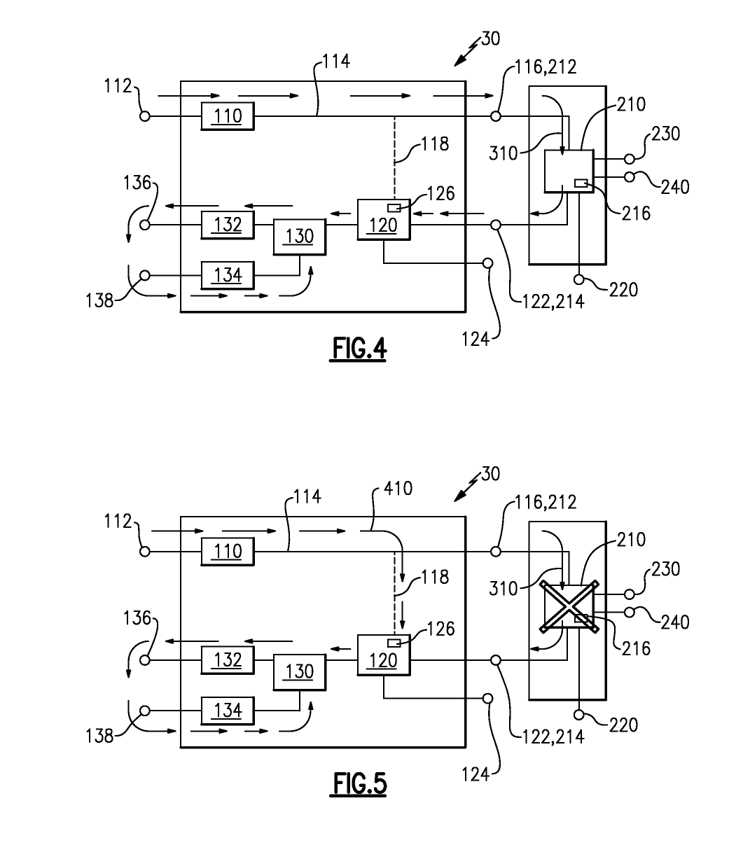

With continued reference to FIGS. 1, 2 and 3, FIG. 4 illustrates a non-faulty control path 310 through an effector module 30. The control path initially receives a signal 310 from the input device 20, and the signal 310 is conditioned in the effector module 30 and passed to the primary control module 40. The primary control module 40 uses the input command and multiple critical and non-critical sensor signals 230, 240 to determine a desired position command that is then passed back to the effector module 30. The effector module 30 then converts the position instruction into a movement instruction in an effector module processor 120, and passes the movement instruction to a closed loop device control 130, 132, 134 that provides the control signals to the effector/actuator 50.

When a fault occurs in the primary control module 40, the control loop 310 is broken and a backup control loop is utilized in its place. With continued reference to FIGS. 1, 2, 3 and 4, FIG. 5 illustrates the backup control loop that occurs when the primary control module 40 experiences a fault and is unable to continue functioning. In the backup control path, the effector module 30 initially gets a signal 410 from the input device, and the signal 410 is conditioned in the effector module 30. Once conditioned, the signal 410 is passed directly to the effector module processor 120 over the backup control link 118. In one example, the effector module processor 120 uses only flight critical sensor information 124 combined with the processed input command signal to determine a component movement command, and passes the component movement command to the closed loop device control 130, 132, 134 that provides the control signals to the actuator 50. In an alternate example, the effector module processor 120 also has access to non-flight critical sensor information.

Each of the components within the effector module 30 can be individual electronic components stored within a single effector module housing, or sub processes stored on a single digital controller (such as the effector module processor 120). Furthermore, in a practical implementation of the illustrated control scheme, the effector module 30 and the primary control module 40 are located in close physical proximity to each other. In a further practical example, the effector module 30 and the primary control module 40 are contained within a single aircraft controller housing.

While the above control system is described with regard to receiving a pilot input command from a control stick or autopilot and controlling a corresponding effector/actuator, it is understood that the described control scheme can be utilized with any form of pilot or autopilot input and any controlled component of an aircraft and is not limited to a control stick controlling an effector/actuator.

It is further understood that any of the above described concepts can be used alone or in combination with any or all of the other above described concepts. Although an embodiment of this invention has been disclosed, a worker of ordinary skill in this art would recognize that certain modifications would come within the scope of this invention. For that reason, the following claims should be studied to determine the true scope and content of this invention.

1. An aircraft control system comprising:
a control input;
an effector module connected to said control input, said effector module including at least one microprocessor, and having at least a primary control module output, a primary control module input, and a controlled device output;
a primary control module connected to said primary control module output of said effector module and said primary control module input of said effector module, said primary control module including at least one microprocessor; and
wherein said at least one microprocessor in said effector module provides a backup control path bypassing said primary control module when said primary control module is in a failed state.

2. The aircraft control system of claim 1, wherein said at least one effector module microprocessor and said at least one primary control module microprocessor have distinct hardware architectures.

3. The aircraft control system of claim 1, wherein said effector module further comprises a flight critical sensor systems input, wherein said flight critical sensor input is one or more flight critical parameter.

4. The aircraft control system of claim 1, wherein said primary control module includes a flight critical sensor systems input, and a non flight critical sensor systems input wherein said non-flight critical sensor systems input is one or more non-flight critical parameter.

5. The aircraft control system of claim 1, wherein said effector module microprocessor includes a memory storing instructions operable to cause said effector module processor to generate a movement command based on a pilot input command from said control input when said primary control module is in a failed state.

6. The aircraft control system of claim 1, wherein each of said at least one effector module microprocessor and said primary control module microprocessor are digital controllers.

7. The aircraft control system of claim 2, further comprising:
a second control input;
a second effector module connected to said second control input, said second effector module including at least one microprocessor, and having at least a primary control module output, a primary control module input, and a controlled device output; and
a second primary control module connected to said primary control module output of said second effector module and said primary control module input of said second effector module, said primary control module including at least one microprocessor;
wherein said at least one processor in said second effector module provides a backup control path bypassing said second primary control module when said second primary control module is in a failed state.

8. The aircraft control system of claim 7, wherein each of said primary control module and said second primary control module comprises an input/output link connected to the input/output link of the other of said primary control module and said second primary control module.

9. The aircraft control system of claim 1, wherein said effector module further comprises a control input processing module, a control loop processing module, a control loop output processing module, and a control loop input processing module.

10. The aircraft control system of claim 9, wherein at least one of said input processing module, a control loop processing module, a control loop output processing module, and a control loop input processing module is a software module stored on a memory of said effector module microprocessor.

11. The aircraft control system of claim 9, wherein at least one of said input processing module, a control loop processing module, a control loop output processing module, and a control loop input processing module is a distinct physical module from said effector module microprocessor.

12. A method of controlling an aircraft system comprising the steps of:
receiving a pilot or autopilot input command at an effector module;
determining a movement instruction for a controlled aircraft component based on said pilot input command and at least flight critical sensor information in a microprocessor of said effector module when a primary control module is in a failed state; and
outputting said movement instruction to said controlled aircraft component, thereby controlling said controlled aircraft component.

13. The method of claim 12, further comprising the steps of:
determining a position instruction for said controlled aircraft component based on said pilot or autopilot input command, at least one flight critical sensor input and at least one non-flight critical sensor input; and
translating said position instruction to a movement instruction readable by said controlled aircraft component using an effector module processor.

14. The method of claim 13, wherein said steps of determining a position instruction for said controlled aircraft component based on said pilot input command, at least one flight critical sensor input and at least one non-flight critical sensor input, and translating said position instruction to a movement instruction readable by said controlled aircraft component using an effector module processor are performed digitally.

15. An aircraft control system comprising:
a control input;
an effector module connected to said control input, said effector module including at least one microprocessor, and having at least a primary control module output, a primary control module input, and a controlled device output;
a primary control module connected to said primary control module output of said effector module and said primary control module input of said effector module, said primary control module including at least one microprocessor; and
wherein said at least one microprocessor in said effector module is operable to provide a backup control path bypassing said primary control module in response to said primary control module entering a failed state.

16. The aircraft control system of claim 15, wherein said at least one effector module microprocessor and said at least one primary control module microprocessor have distinct hardware architecture.

17. The aircraft control system of claim 15, wherein each of said at least one effector module microprocessor and said primary control module microprocessor are digital controllers.

18. The aircraft control system of claim 15, further comprising:
a second control input;
a second effector module connected to said second control input, said second effector module including at least one microprocessor, and having at least a primary control module output, a primary control module input, and a controlled device output; and
a second primary control module connected to said primary control module output of said second effector module and said primary control module input of said second effector module, said primary control module including at least one microprocessor;
wherein said at least one processor in said second effector module provides a backup control path bypassing said second primary control module when said second primary control module is in a failed state.

19. The aircraft control system of claim 18, wherein each of said primary control module and said second primary control module comprises an input/output link connected to the input/output link of the other of said primary control module and said second primary control module.

20. The aircraft control module of claim 1, wherein said at least one microprocessor in said effector module includes stored instructions operable to cause said at least one microprocessor in said effector module to convert a determined position instruction received at the at least one primary control module input into movement commands for an effector/actuator when a primary control module is in a non-failed state.

21. The aircraft control system of claim 20, wherein the determined position instruction is a determined position instruction output by said primary control module.

22. The method of claim 12, further comprising:
passing said pilot or autopilot input command from said effector module to a primary control module when said primary control module is in a non-failed state; and
determining a position instruction for said controlled aircraft component based on said pilot or autopilot input command, at least one flight critical sensor input and at least one non-flight critical sensor input using said primary control module, passing said determined position instruction from said primary control module to said effector module, and translating said position instruction to a movement instruction readable by said controlled aircraft component using an effector module processor when said primary control module is in the non-failed state.

23. The aircraft control system of claim 15, wherein said at least one microprocessor in said effector module includes stored instructions operable to cause said at least one microprocessor in said effector module to convert a determined position instruction received at the at least one primary control module input into movement commands for an effector/actuator when a primary control module is in a non-failed state.
